(19) United States
(12) Patent Application Publication
(10) Pub. No.: US 2022/0164849 A1
(43) Pub. Date: May 26, 2022

(54) METHOD AND APPARATUS FOR CLASSIFYING ITEM BASED ON MACHINE LEARNING

(71) Applicant: EMRO CO., LTD., Seoul (KR)

(72) Inventors: Jae Min Song, Seoul (KR); Kwang Seob Kim, Seoul (KR); Ho Jin Hwang, Seoul (KR); Jong Hwi Park, Gyeonggi-do (KR)

(21) Appl. No.: 17/456,138

(22) Filed: Nov. 22, 2021

(30) Foreign Application Priority Data
Nov. 23, 2020 (KR) 10-2020-0158141

(51) Int. Cl. G06Q 30/06; G06N 20/00

(52) U.S. Cl. CPC G06Q 30/0627; G06N 20/00

(57) ABSTRACT

Provided is a method for classifying an item based on machine learning, the method including, when pieces of information about a plurality of items are received, tokenizing each of the pieces of information about the items in units of words, creating a sub-word vector corresponding to a sub-word having a length less than a length of each of the words via machine learning, creating a word vector corresponding to each of the words and a sentence vector corresponding to each of the pieces of information about the items based on the sub-word vectors, and classifying the pieces of information about the plurality of items based on a similarity between the sentence vectors.

### CROSS-REFERENCE TO RELATED APPLICATION(S)

Any and all applications for which a foreign or domestic priority claim is identified in the Application Data Sheet as filed with the present application are hereby incorporated by reference under 37 CFR 1.57.

This application claims the benefit of Korean Patent Application No. 10-2020-0158141, filed on Nov. 23, 2020, in the Korean Intellectual Property Office, the disclosure of which is incorporated herein by reference.

### BACKGROUND

### Field

The present disclosure relates to a method and apparatus for classifying an item based on machine learning. More particularly, the present disclosure relates to a method for classifying classification target item information using a learning model created through machine learning, and an apparatus using the same.

### Description of the Related Technology

Natural language processing (NLP) is one of the main fields of artificial intelligence in which research that enables machines such as computers to imitate human language phenomena is performed and realized. With the development of machine learning and deep learning techniques in recent years, language processing research and development have been actively conducted to extract and utilize meaningful information from huge amounts of text through machine learning and deep learning-based natural language processing.

Document in the related art: Korean Patent Publication No. 10-1939106.

The document in the related art discloses an inventory management system and inventory management method using a learning system. As such, companies need to standardize, integrate, and manage various types of pieces of information produced by the companies to improve work efficiency and productivity. For example, when items purchased by the companies are not systematically managed, duplicate purchases may occur and it may be difficult to search for an existing purchase history. The document in the related art discloses technical features of creating a predictive model and performing inventory management based on the predictive model, but does not disclose a specific prediction model creation method or an item classification method specialized for inventory management.

Various types of pieces of information related to items which have been previously used by companies are raw text in which item classification is not separately performed in many cases, and thus, there is a need for a method and system for managing pieces of information related to items based on natural language processing.

### SUMMARY

An aspect provides a method and apparatus capable of classifying a plurality of items on the basis of pieces of information about the plurality of items and outputting information about similar or overlapping items among the plurality of items.

Another aspect also provides a method and apparatus capable of classifying a plurality of items from pieces of text information related to the items using a learning model related to item information.

The technical object to be achieved by the present example embodiments is not limited to the above-described technical objects, and other technical objects which are not described herein may be inferred from the following example embodiments.

According to an aspect, there is provided a method of classifying an item based on machine learning including, when pieces of information about a plurality of items are received, tokenizing each of the pieces of information about the items in units of words, creating a sub-word vector corresponding to a sub-word having a length less than a length of each word through machine learning, creating a word vector corresponding to the each word and a sentence vector corresponding to each of the pieces of information about the items on the basis of the sub-word vectors, and classifying the pieces of information about the plurality of items on the basis of a similarity between the sentence vectors.

According to another aspect, there is also provided an apparatus for classifying an item based on machine learning including a memory configured to store at least one instruction, and a processor configured to execute the at least one instruction to, when pieces of information about a plurality of items are received, tokenize each of the pieces of information about the items into units of words, create a sub-word vector corresponding to a sub-word having a length less than a length of each word through machine learning, create a word vector corresponding to the each word and a sentence vector corresponding to each of the pieces of information about the items on the basis of the sub-word vectors, and classify the pieces of information about the plurality of items on the basis of a similarity between the sentence vectors.

According to still another aspect, there is also provided there is provided a computer-readable non-transitory recording medium recording a program for executing a method of classifying an item based on machine learning on a computer, and the method of classifying an item based on machine learning includes, when pieces of information about a plurality of items are received, tokenizing each of the pieces of information about the items in units of words, creating a sub-word vector corresponding to a sub-word having a length less than a length of each word through machine learning, creating a word vector corresponding to the each word and a sentence vector corresponding to each of the pieces of information about the items on the basis of the sub-word vectors, and classifying the pieces of information about the plurality of items on the basis of a similarity between the sentence vectors.

Specific details of other example embodiments are included in the detailed description and drawings.

In a method and apparatus for classifying an item according to the present disclosure, a sentence vector is created using a sub-word vector corresponding to a sub-word having a length less than that of each word. Thus, there is an effect of reducing the degradation of similarity measurement performance that may occur due to a newly input word or a misspelling and omission.

Further, in a method and apparatus for classifying an item according to the present disclosure, a weight can be assigned to at least one word. Thus, when a weight value of each word is different, there is an effect that can calculate different similarity results even when information about the same item is input.

It should be noted that advantageous effects of the present disclosure are not limited to the above-described effects, and other effects that are not described herein will be clearly understood by those skilled in the art from the following claims.

### BRIEF DESCRIPTION OF THE DRAWINGS

FIG. 1 is a diagram for describing an item management system according to an example embodiment of the present disclosure.

FIGS. 2A and 2B are diagrams for describing a method of managing information about an item according to an example embodiment of the present disclosure.

FIGS. 3A to 4B are diagrams for describing a method of performing vectorization on information about an item, according to an example embodiment.

FIGS. 5A to 5C are diagrams for describing a method of creating a vector to be included in a word embedding vector table according to an example embodiment.

FIG. 6 is a diagram for describing a method of pre-processing information about an item before performing item classification, according to an example embodiment.

FIG. 7 is a diagram for describing parameters that may be adjusted when a learning model related to item classification is created, according to an example embodiment.

FIG. 8 is a diagram for describing a method of providing pieces of information about a pair of similar or overlapping items by an item classification apparatus according to an example embodiment.

FIGS. 9A to 11B are diagrams for describing item classification results according to an example embodiment.

FIG. 12 is a flowchart for describing a method for classifying an item based on machine learning according to an example embodiment.

FIG. 13 is a block diagram for describing an apparatus for classifying an item based on machine learning according to an example embodiment.

### DETAILED DESCRIPTION

Terms used in example embodiments are general terms that are currently widely used while their respective functions in the present disclosure are taken into consideration. However, the terms may be changed depending on the intention of one of ordinary skilled in the art, legal precedents, emergence of new technologies, and the like. Further, in certain cases, there may be terms arbitrarily selected by the applicant, and in this case, the meaning of the term will be described in detail in the corresponding description. Accordingly, the terms used herein should be defined based on the meaning of the term and the contents throughout the present disclosure, instead of the simple name of the term.

Throughout the specification, when a part is referred to as including a component, unless particularly defined otherwise, it means that the part does not exclude other components and may further include other components.

The expression “at least one of a, b, and c,” should be understood as including only a, only b, only c, both a and b, both a and c, both b and c, or all of a, b, and c.

Example embodiments of the present disclosure that are easily carried out by those skilled in the art will be described in detail below with reference to the accompanying drawings. The present disclosure may, however, be implemented in many different forms and should not be construed as being limited to the example embodiments described herein.

Example embodiments of the present disclosure will be described in detail below with reference to the drawings.

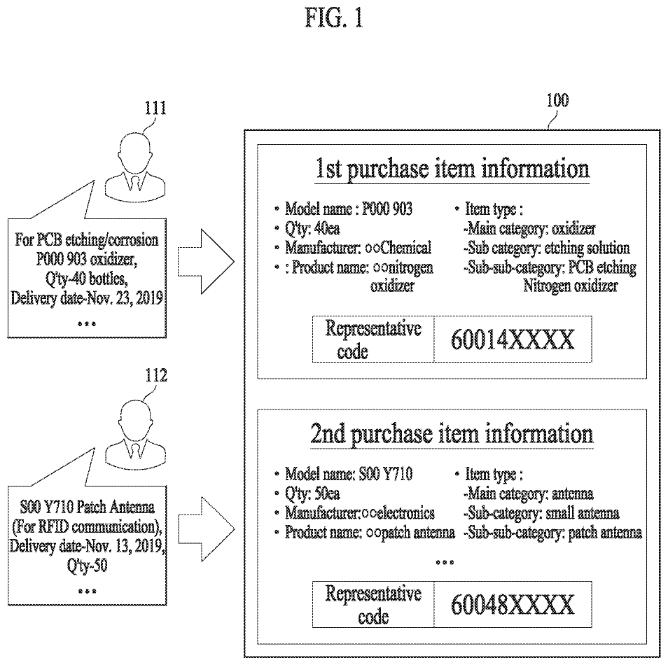

FIG. 1 is a diagram for describing an item management system according to an example embodiment of the present disclosure.

When pieces of information about items are received, an item management system 100 according to an example embodiment of the present disclosure may process information about each item in a unified format and assign codes to the items to which a separate code is not assigned, and the code that is initially assigned to a specific item may be a representative code. In an example embodiment, the item information may include a general character string and may be a character string including at least one delimiter. In an example embodiment, the delimiter may include, but is not limited thereto, a space character and punctuation marks and may include a character capable of distinguishing between specific items.

Referring to FIG. 1, the item management system 100 may receive pieces of purchase item information from a plurality of managers 111 and 112. In an example embodiment, the purchase item information may be a purchase request for purchasing the corresponding item, and in this case, the pieces of purchase item information received from the plurality of managers 111 and 112 may be different in format, and thus there may be a difficulty in integrating and managing a plurality of purchase requests.

Accordingly, the item management system 100 according to an example embodiment may perform machine learning on the basis of existing item information, process the pieces of purchase item information received from the plurality of managers 111 and 112 in a predetermined format according to learning results generated through the machine learning, and store the processed item information.

For example, the item information provided by a first manager 111 may include only a specific model name (e.g., “P000_903”) and a use (for printed circuit board (PCB) etching/corrosion) of the item, but may not include information required for classifying the item (e.g., information about a main-category, a sub-category, and a sub-sub-category). In this case, when the item information provided by the first manager 111 is received, the item management system 100 may classify the item and attribute information of the item on the basis of a result of the machine learning, and may store and output a classification result.

Further, even when the order of all attribute items included in the item information provided by the first manager 111 is different from the order of all attribute items included in the item information provided by a second manager 112, the item management system 100 may classify and store the attribute information by identifying each of the attribute items. Meanwhile, in an example embodiment, the first manager 111 and the second manager 112 may be the same manager. Further, even when pieces of information about the same item are recorded differently due to a misspelling or a display form, by determining a similarity between the pieces of input item information according to the learning result of the learning model, an operation such as determining the similarity between the received item and the already input item or assigning a new representative code to the received item may be performed.

Accordingly, in the item management system 100 according to an example embodiment, the efficiency of managing information about each item may be increased.

Meanwhile, in FIG. 1, the description is provided on the assumption that the item management system 100 is for the purpose of integrally managing information related to an item purchase, but the use of the item management system 100 is not limited to the item purchase, and the item management system 100 may also be used for reclassifying the corresponding information based on the already input item information. Thus, it is clear for those skilled in the art that the example embodiment of the present specification may be applied to all systems for integrating and managing a plurality of items. In other words, it is clear that the example embodiment of the present specification may be utilized in processing previously-stored item information as well as in requesting a purchase of an item.

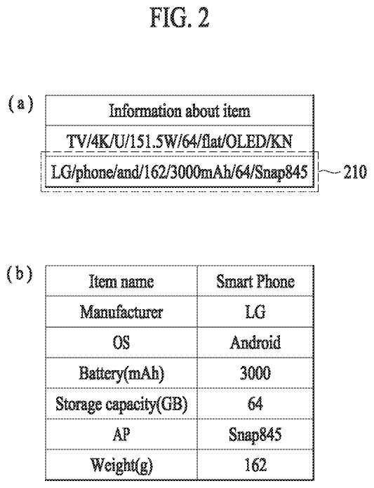

FIGS. 2A and 2B are diagrams for describing a method of managing information about an item according to an example embodiment of the present disclosure.

When information about an item is received, the item management system according to an example embodiment may classify pieces of attribute information in the received information on the basis of each attribute item. Here, the information about the item may include a plurality of pieces of attribute information, and the pieces of attribute information may be classified according to the attribute item. More specifically, the information about the item may be a character string including a plurality of pieces of attribute information, and the item management system may classify the information about the item to derive information corresponding to each attribute.

Referring to FIG. 2A, the item management system may receive pieces of information about a plurality of items, which have different formats. For example, the item management system may perform crawling or receive the pieces of information about the plurality of items from a customer database, and may receive the pieces of information about the plurality of items through a user's input. At this time, this may be in the state in which attribute items (an item name, a manufacturer, an operating system (OS), and the like) included in the pieces of information about the item are not identified.

In this case, the item management system according to an example embodiment may classify each attribute information included in the information about the item through machine learning. For example, pieces of item information 210 shown in FIG. 2A may be classified into pieces of attribute information according to various attribute items including an item name as shown in FIG. 2B. In the example embodiment, the management system may determine which attribute corresponds to each piece of information classified according to a learning model, check the item to which the character string for one item corresponds based on a value corresponding to each attribute, and check information about the item of the same category, thereby collectively managing such items.

According to the item management system, pieces of information corresponding to all attributes may be derived from the information about the item and divided and stored, and even when a character string corresponding to the pieces of information is input later, the corresponding character string may be analyzed to check the corresponding attribute value, classified, and stored.

Thus, the item management system according to an example embodiment may standardize pieces of information about items, manage main attribute information, and thus may classify the items that are similar or overlapping, thereby increasing the convenience of data maintenance.

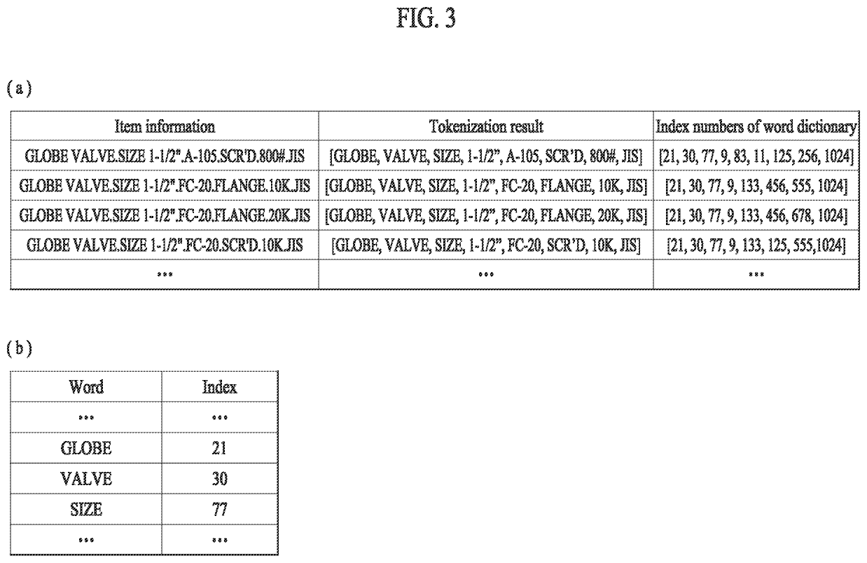

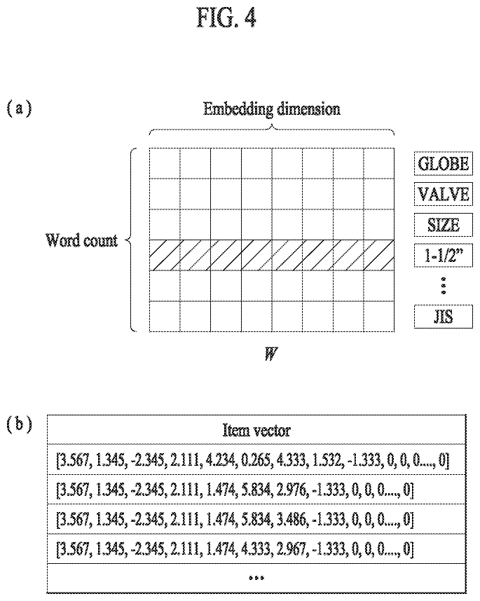

FIGS. 3A to 4B are diagrams for describing a method of performing vectorization on information about an item, according to an example embodiment.

Meanwhile, an apparatus for classifying an item of the present disclosure may be an example of the item management system. In other words, an example embodiment of the present disclosure may relates to the apparatus for classifying an item on the basis of information about an item. Meanwhile, the item classification apparatus may create a vector by tokenizing pieces of information about items into units of words.

Referring to FIG. 3A, in the case in which information about an item is [GLOBE VALVE, SIZE 1½,″ A-105, SCR'D, 800 #, JIS], the information about the item may be tokenized into units of each word, and on the basis of the tokenization result [GLOBE, VALVE, SIZE, 1½,″ A-105, SCR'D, 800 #, JIS], it is possible to find an index number corresponding to each token from a word dictionary. Thus, index numbers of the word dictionary of the corresponding tokenization result may be [21, 30, 77, 9, 83, 11, 125, 256, 1024].

The index numbers of the word dictionary may be defined as pieces of information in which the pieces of item information are listed as index values of words based on the word dictionary obtained by indexing words extracted from an entire training data set. In addition, the index numbers of the word dictionary may be used as key values for finding vector values of words from a word embedding vector table.

Here, in an example embodiment, the tokenization in units of words may be performed on the basis of at least one of a space character and punctuation marks. As described above, the tokenization may be performed on the basis of at least one of the space character and the punctuation marks, and tokenized words may include information indicating the corresponding item but may not be words that are written in a typical dictionary. The tokenized words may be, but are not limited thereto, words having information for representing an item and may include words that do have an actual meaning.

To this end, the item classification apparatus may store a word dictionary as shown in FIG. 3B. The index number corresponding to “GLOBE” in FIG. 3A may be “21” as shown in FIG. 3B, and accordingly, as the index number of the word dictionary corresponding to “GLOBE,” “21” may be stored. Similarly, in the case of “VALVE,” “30” may be stored as the index number, and in a case of “SIZE,” “77” may be stored as the index number.

Meanwhile, a vector corresponding to each word may be determined on the basis of the word embedding vector table in which each word included in the information about the item is mapped to each vector. In order to create the word embedding vector table, a word2vec algorithm may be utilized, but the method of creating vectors is not limited thereto. Of the word2vec algorithm, a word2vec skip-gram algorithm is a technique of predicting several surrounding words of each word constituting a sentence using the each word. For example, when a window size of the word2vec skip-gram algorithm is three, a total of six words may be output when a single word is input. Meanwhile, in an example embodiment, by changing the window size, a vector value may be created in various units for the same item information, and learning may be performed in consideration of the created vector values.

The word embedding vector table may be in the form of a matrix composed of a plurality of vectors each represented as an embedding dimension as shown in FIG. 4A. In addition, the number of rows in the word embedding vector table may correspond to the number of words included in pieces of information about a plurality of items. An index value of the word may be used for finding a vector value of the corresponding word from the word embedding vector table. In other words, a key value of the word embedding vector table utilized as a lookup table may be the index value of the word. Meanwhile, each item vector may be illustrated as shown in FIG. 4B.

Meanwhile, in the case in which the tokenization is performed in units of words, when a word, which is not included in the word embedding vector table, is input, since a vector corresponding to the word does not exist, it may be difficult to create the vector corresponding to the information about the item. In addition, in the case in which several words, which do not exist in the word embedding vector table, are included in the information about the item, item classification performance may degrade.

Accordingly, the item management system according to an example embodiment may create the word embedding vector table related to the pieces of information about the items using sub-words of each word included in the information about the item.

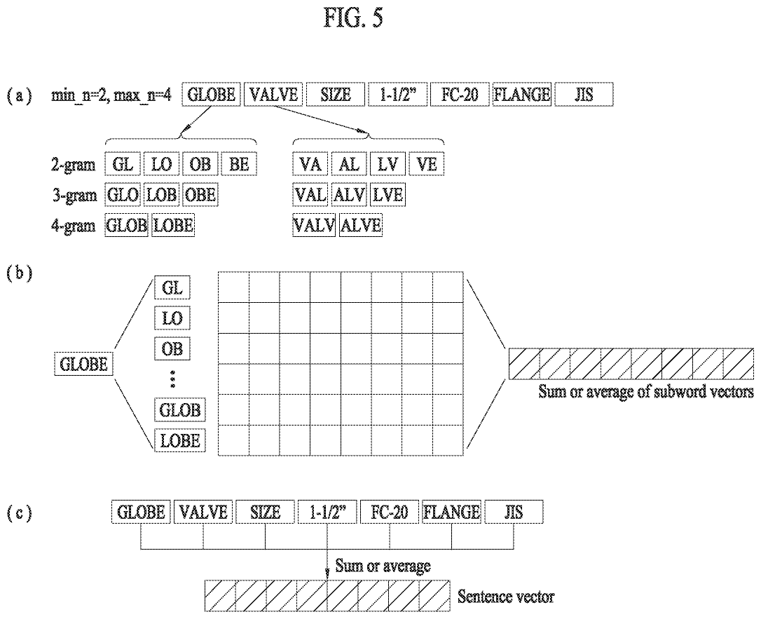

FIGS. 5A to 5C are diagrams for describing a method of creating a vector to be included in the word embedding vector table according to an example embodiment.

Referring to FIG. 5A, after the tokenization is performed in units of words, sub-word vectors respectively corresponding to sub-words of each word may be created. For example, with respect to a word “Globe Polygon,” when 2-gram sub-words are generated, four sub-words “GL,” “LO,” “OB,” and “BE” may be generated, and when 3-gram sub-words are generated, three sub-words “GLO,” “LOB,” and “OBE” may be generated. In addition, when 4-gram sub-words are generated, two sub-words “GLOB” and “LOBE” may be generated.

Referring to FIG. 5B, the item classification apparatus according to an example embodiment may extract sub-words of each word, and create a sub-word vector corresponding to each sub-word by performing machine learning on the sub-words. In addition, a vector of each word may be created by summing the vector of each sub-word. Thereafter, a word embedding vector table shown in FIG. 5B may be created using the vector of each word. Meanwhile, the vector of each word may be created on the basis of an average of the sub-word vectors, as well as the sum of the sub-word vectors, but the present disclosure is not limited thereto.

Meanwhile, when the vector of each word is created using the sub-word vectors, item classification performance may be maintained even when a misspelling is included in input item information.

Thereafter, referring to FIG. 5C, the item classification apparatus may create a sentence vector corresponding to the information about the item by summing or averaging the word vectors each corresponding to each word. At this time, an embedding dimension of the sentence vector is the same as an embedding dimension of each word vector. That is, a length of the sentence vector and a length of each word vector are the same.

Here, a character count and type of the sub-words are not limited thereto, and it is clear to those skilled in the art that the character count and type of the sub-words may vary depending on the system design requirements.

Meanwhile, when classifying an item, the item classification apparatus according to an example embodiment may create a vector by assigning a weight to each word included in information about the item.

For example, information about a first item may be [GLOBE, VALVE, SIZE, 1½,″ FC-20, P/N:100, JIS], and information about a second item may be [GLOVE, VALV, SIZE, 1⅓,″ FC20, P/N:110, JIS]. In this case, when a vector corresponding to the information about the item is created by assigning weights to words related to a size and a part number among attribute items included in the information about the item, a similarity between the pieces of information about the two items different in size and part number may be lowered. In addition, when the vectors corresponding to the pieces of information about the items are different from each other due to a misspelling and omission of a special character or the like in items with relatively low weights, a similarity between the pieces of information about the two items may be relatively high. Meanwhile, in an example embodiment, the character to which the weight is applied may be differently set according to the type of the item. In an example embodiment, for items that have the same item name but need to be classified as different items according to attribute values, a high weight may be assigned to the corresponding attribute value, and based on this, a similarity may be determined. In addition, in the learning model, attribute values that need to be assigned such a high weight may be identified, and based on the classification data, when items with the same name have different attribute information, the high weight may be assigned to such attribute information.

Accordingly, the item management system according to an example embodiment may further improve the item classification performance by creating the vector after assigning a weight to each attribute included in the information about the item.

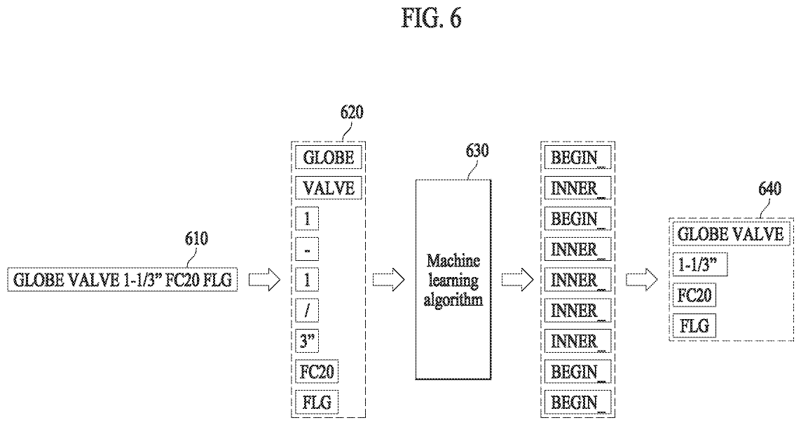

FIG. 6 is a diagram for describing a method of pre-processing the information about the item before performing the item classification, according to an example embodiment.

Meanwhile, each attribute information included in the information about the item may be information classified using a delimiter, and may also be composed of a continuous character without a delimiter. When each attribute item included in the information about the item is not distinguished and input as a continuous character, it may be difficult to identify each attribute item without pre-processing. In this case, the item classification apparatus according to an example embodiment may pre-process the information about the item before performing the item classification.

Specifically, before calculating a similarity between the pieces of information about the items, the item classification apparatus according to an example embodiment may perform the pre-processing to identify each word included in the information about the item through machine learning.

Referring to FIG. 6, when the information about the item is input as a continuous character string 610, the item classification apparatus according to an example embodiment may classify characters in the continuous character string 610 into units for tagging on the basis of a space character or a specific character. Here, a character string 620 of units for tagging is defined as a character string having a length less than that of a character string 640 of a tokenization unit, and refers to units to which a start tag “BEGIN_,” a contiguous tag “INNER_,” and an end tag “O_” are added.

After that, the item classification apparatus may add the tag to each unit for tagging of the character string 620 using a machine learning algorithm 630. For example, the “BEGIN_” tag may be added to “GLOBE” of FIG. 6, and the “INNER_” tag may be added to “I” of FIG. 6.

Meanwhile, the item classification apparatus may recognize from a token to which the start tag “BEGIN_” is added to a token to which the end tag “0” is added as one word, or recognize from the token to which the start tag “BEGIN_” is added to a token before a token to which a next start tag “BEGIN_” is added as one word. Accordingly, the item classification apparatus may recognize the character string 640 of a tokenization unit from the continuous character string 610.

Thus, according to the method disclosed in FIG. 6, the item classification apparatus may classify the information about the item after identifying each token included in the information about the item.

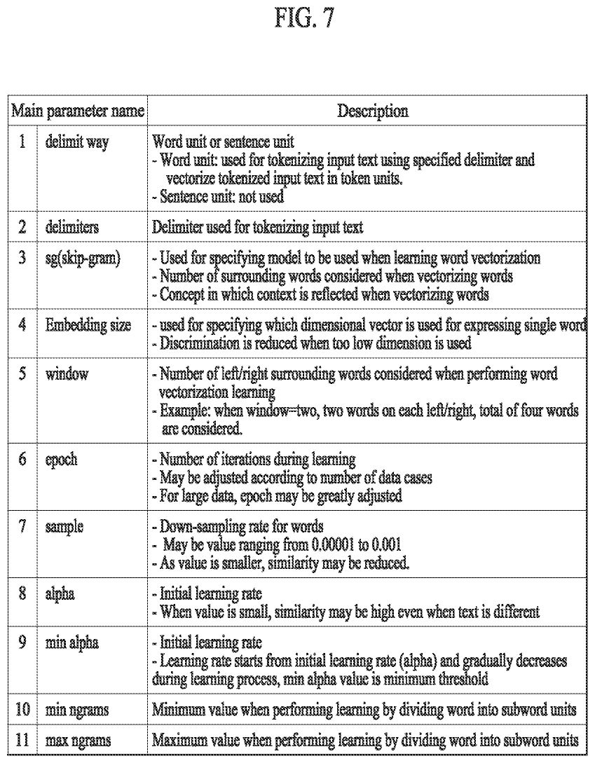

FIG. 7 is a diagram for describing parameters that may be adjusted when a learning model related to item classification is created, according to an example embodiment.

Meanwhile, the method for classifying an item according to an example embodiment may be improved in performance by adjusting the parameters. Referring to FIG. 7, the method for classifying an item may adjust from a first parameter “delimit way” to an eleventh parameter “max ngrams” according to system design requirements. Among these, from a fifth parameter “window” to the eleventh parameter “max ngrams” may be relatively frequently adjusted in the method for classifying an item according to an example embodiment.

For example, when a tenth parameter “min ngrams” is two and the eleventh parameter “max ngrams” is five, which may mean that a single word is divided into two, three, four, and five character units and is learned and then vectorized.

Meanwhile, the parameters that may be adjusted for the method for classifying information about an item are not limited to those in FIG. 7, and it is clear to those skilled in the art that the parameters may be changed according to system design requirements.

Meanwhile, in the example embodiment, after the learning model is created, when an accuracy of a result of processing item data through the learning model is reduced, a new learning model may be created or additional learning may be performed by adjusting at least one of the above parameters. The learning model may be updated or newly created by performing at least one of the parameters so as to correspond to the description of FIG. 7.

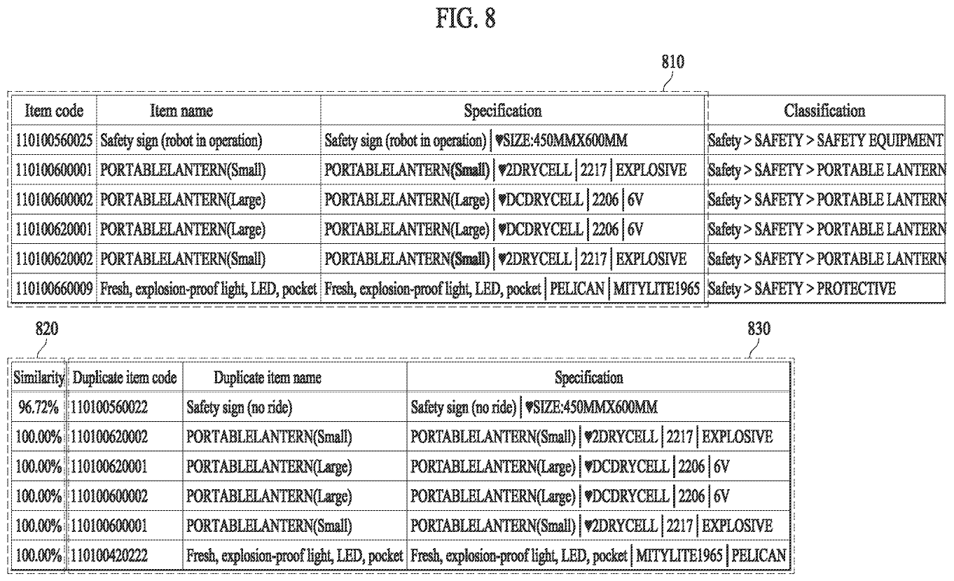

FIG. 8 is a diagram for describing a method of providing pieces of information about a pair of similar or overlapping items by the item classification apparatus according to an example embodiment.

The item classification apparatus according to an example embodiment may perform machine learning using pieces of information about a plurality of items, and classify each piece of information about the item using a learning model.

When an item code is not included in the information about the item, the item classification apparatus according to an example embodiment may generate an item representative code corresponding to each item through machine learning and classify each item. The representative codes generated by the item classification apparatus may then be utilized to manage purchases, figures, and the like.

In addition, when pieces of information about similar or overlapping items exist in the pieces of information about the plurality of items, the item classification apparatus may provide information related to this fact to the user.

Referring to FIG. 8, pieces of item information 820 similar to or overlapping pieces of item information 810 may be provided to the user together with similarities 830. Meanwhile, a method of displaying an item classification result is not limited to FIG. 8, and it is clear to those skilled in the art that the item classification result may be changed depending on system design requirements.

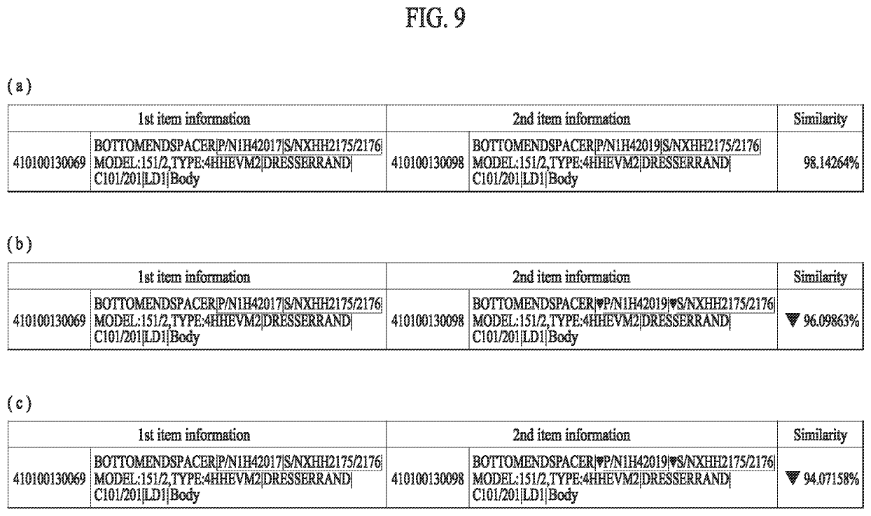

FIGS. 9A to 11B are diagrams for describing an item classification result according to an example embodiment.

The apparatus for classifying an item according to an example embodiment may generate a vector after assigning a weight to each attribute included in the information about the item, and based on this, the apparatus for classifying an item may calculate a similarity. At this time, when values of attribute items, to which a relatively high weight is applied, among pieces of attribute information included in pieces of information about two items are different, a similarity between the pieces of information about the two items may be lowered. In contrast, when the values of the attribute items to which a relatively high weight is applied are the same, the similarity between the pieces of information about the two items may be increased.

FIG. 9A illustrates a result of calculating a similarity between information about a first item and information about a second item in a case in which a weight is not reflected in each attribute item, and FIGS. 9B and 9C illustrate results of calculating a similarity between the information about the first item and the information about the second item after weights are assigned to items of a part number “P/N” and a serial number “S/N.” Further, the weight assigned to items of the part number “P/N” and the serial number “S/N” in FIG. 9B is greater than the weight assigned to the items of the part number “P/N” and the serial number “S/N” of FIG. 9C.

First, it may be seen that a similarity result of each of FIGS. 9B and 9C is lower than that of FIG. 9B because the part numbers “P/N,” to which the weight is assigned, are different. In addition, it may be seen that the overall similarity result of FIG. 9C is relatively lower than that of FIG. 9B because the weight assigned to the part number “P/N” of FIG. 9C is greater than the weight assigned to the part number “P/N” of FIG. 9B.

The influence of the weight is reduced in the similarity result calculated by the item classification apparatus according to an example embodiment as the number of attribute items included in the information about the item increases. Accordingly, the item classification apparatus according to an example embodiment may assign a greater weight to some attribute items included in the information about the corresponding item as the number of the attribute items included in the information about an item increases.

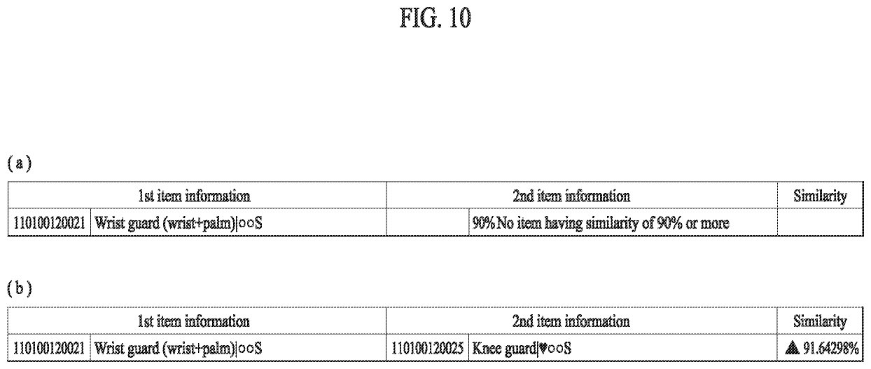

Meanwhile, referring to FIGS. 10A and 10B, it may be seen that a weight is assigned to an attribute item “OTOS” shown after a special symbol. At this time, since the number of attribute items included in each of information about a first item and information about a second item is two, which is a relatively small number, the similarity result may vary significantly depending on whether the attribute items to which a weight is assigned are the same. Meanwhile, FIG. 10B illustrates the similarity between the information about the first item and the information about the second item, which have the same attribute and to which the weight is assigned, and the similarity result may be significantly increased as compared to a case in which the weight is not assigned.

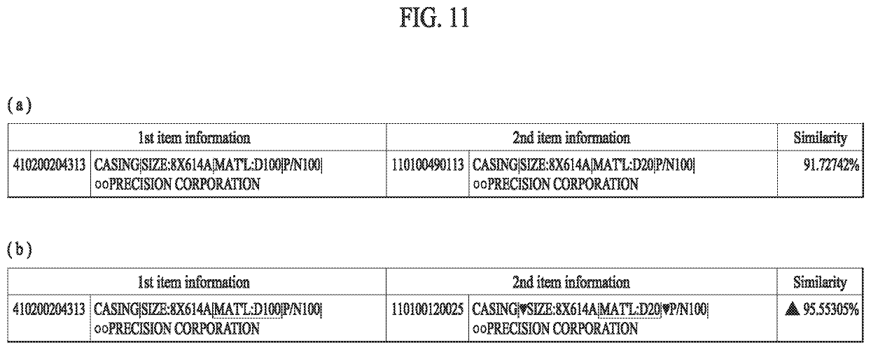

Referring to FIGS. 11A and 11B, it may be seen that a weight is assigned to attributes of a size “size” and a part number “P/N” shown after a special symbol. At this time, when information about a first item and information about a second item are different in a material attribute item to which a weight is not assigned, a similarity between the two pieces of information may increase as compared to a case in which the weight is not assigned.

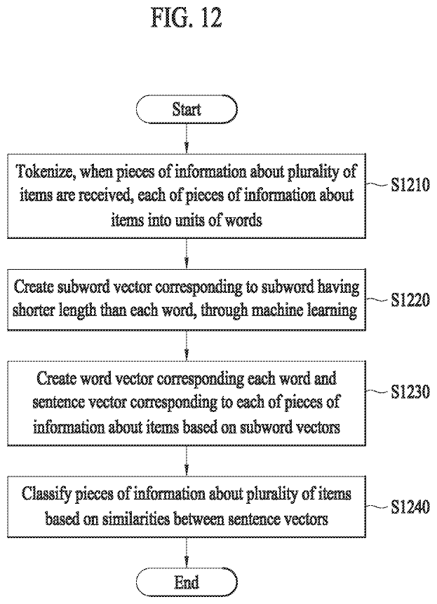

FIG. 12 is a flowchart for describing a method of classifying an item based on machine learning according to an example embodiment.

In operation S1210, when pieces of information about a plurality of items are received, the method may tokenize each of the pieces of information about the items into units of words.

In operation S1220, the method may generate a sub-word vector corresponding to a sub-word, which has a length less than that of each word, through machine learning. Meanwhile, in the example embodiment, operations S1210 and S1220 may be performed at one time. In order to perform the learning, the information about the item may be directly divided into units of sub-words, and vectors for the divided sub-words may be created.

In operation S1230, the method may generate a word vector corresponding to each word and a sentence vector corresponding to each of the pieces of information about the items on the basis of the sub-word vectors. Here, the word vector may be created on the basis of at least one of a sum or average of the sub-word vectors. In the example embodiment, when the summing or averaging of the vectors is performed, a weight may be applied to each vector, and the weight applied may be changed depending on a learning result or a user input, and the vector to be applied may also be changed.

In operation S1240, the method may classify the pieces of information about the plurality of items on the basis of similarities between the sentence vectors. At this time, operation S1240 may include extracting the pieces of information about the plurality of items having a similarity exceeding a first threshold value.

Meanwhile, operation S1220 may include assigning a weight to at least one word before performing operation S1220, and here, the sentence vector may be changed depending on the weight. In addition, the weight may be changed depending on the number of the attribute items included in the information about an item.

Further, the method may further include creating a word embedding vector table composed of the vectors each corresponding to each word.

Meanwhile, before tokenizing each of the pieces of information about the items, the method may further include classifying the information about the item into one or more character strings of units for tagging on the basis of at least one of a space character or a preset character included in the information about the item, adding a tag to each character string in units for tagging through machine learning, and determining the one or more character strings in units for tagging as tokens on the basis of the tags. In an example embodiment, a length of each the character strings of units for tagging may be variously determined.

At this time, the tags include a start tag, a continuous tag, and an end tag, and the determining of the one or more character strings in units for tagging as tokens may be an operation of determining one token by merging the character string from a token to which the start tag is added to a token before a token to which the next start tag is added or a token to which the end tag is added.

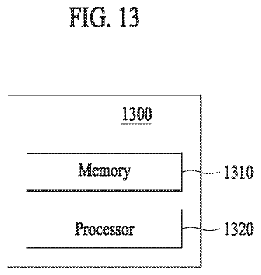

FIG. 13 is a block diagram for describing an apparatus for classifying an item based on machine learning according to an example embodiment.

According to an example embodiment, an item classification apparatus 1300 may include a memory 1310 and a processor 1320. The item classification apparatus 1300 shown in FIG. 13 is illustrated with only constituent elements that are related to the present example embodiment. Accordingly, it will be understood by those of ordinary skill in the art that other general components may be further included in addition to the components illustrated in FIG. 13.

The memory 1310 may be hardware for storing various pieces of data processed in the item classification apparatus 1300, for example, the memory 1310 may store data processed and data to be processed by the item classification apparatus 1300. The memory 1310 may store at least one instruction for the operation of the processor 1320. In addition, the memory 1310 may store programs, applications, and the like that are to be driven by the item classification apparatus 1300. The memory 1310 may include random access memory (RAM) such as a dynamic random access memory (DRAM) or a static random access memory (SRAM), a read-only memory (ROM), an electrically erasable programmable read-only memory (EEPROM), a CD-ROM, Blu-Ray® or other optical disk storage, a hard disk drive (HDD), a solid state drive (SSD), or a flash memory.

The processor 1320 may control the overall operation of the item classification apparatus 1300 and process data and signals. The processor 1320 may generally control the item classification apparatus 1300 by executing at least one instruction or at least one program stored in the memory 1310. The processor 1320 may be implemented as a central processing unit (CPU), a graphics processing unit (GPU), an application processor (AP), or the like, but the present disclosure is not limited thereto.

When pieces of information about a plurality of items are received, the processor 1320 may tokenize each of the pieces of information about the items into units of words, and create a sub-word vector corresponding to a sub-word having a length less than that of each word through machine learning. In addition, the processor 1320 may create a word vector corresponding to each word and a sentence vector corresponding to each of the pieces of information about the items on the basis of the sub-word vectors, and classify the pieces of information about the plurality of items on the basis of similarities between the sentence vectors.

Meanwhile, the processor 1320 may assign a weight to at least one word before performing the machine learning, and the sentence vector may be changed depending on the weight. In addition, the weight may be changed depending on the number of attribute items included in the pieces of information about the items.

Meanwhile, the word vector may be created on the basis of at least one of a sum or average of the sub-word vectors. In addition, the processor 1320 may generate a word embedding vector table composed of vectors each corresponding to each word.

Meanwhile, when classifying the pieces of information about the plurality of items, the processor 1320 may extract the pieces of information about the plurality of items having a similarity exceeding a first threshold value.

Further, before performing tokenization on each of the pieces of information about the items, the processor 1320 may classify the pieces of information about the items in units for tagging on the basis of at least one of a space character or a preset character included in the pieces of information about the items, and add a tag to each of the units for tagging through the machine learning. In addition, one or more units for tagging may be determined as tokens on the basis of the tags. Here, the tags may include a start tag, a continuous tag, and an end tag.

Meanwhile, when the processor 1320 determines the one or more units for tagging as tokens, the units for tagging from a token to which the start tag is added to a token to which a next start tag is added, or a token to which the end tag is added may be determined as one token.

The processor according to the example embodiments described above may include a processor, a memory for storing and executing program data, a permanent storage such as a disk drive, a communication port for communicating with external devices, and user interface devices, such as a touch panel, keys, buttons, and the like. Methods may be implemented with software modules or algorithms and may be stored as program instructions or computer-readable codes executable on a processor on a computer-readable recording medium. Examples of the computer-readable recording medium include magnetic storage media (e.g., read-only memory (ROM), random-access memory (RAM), floppy disks, hard disks, and the like), optical recording media (e.g., CD-ROMs, or digital versatile discs (DVDs)), and the like. The computer-readable recording medium may also be distributed over network coupled computer systems so that the computer-readable codes are stored and executed in a distributive manner. The media may be readable by the computer, stored in the memory, and executed by the processor.

The present example embodiment may be described in terms of functional block components and various processing operations. Such functional blocks may be implemented by any number of hardware and/or software components configured to perform the specified functions. For example, these example embodiments may employ various integrated circuit (IC) components, e.g., memory elements, processing elements, logic elements, look-up tables, and the like, which may perform various functions under the control of one or more microprocessors or other control devices. Similarly, where components are implemented using software programming or software components, the present example embodiments may be implemented with any programming or scripting language including C, C++, Java, Python, or the like, with the various algorithms being implemented with any combination of data structures, processes, routines or other programming components. However, such languages are not limited, and program languages that may be used to implement machine learning may be variously used. Functional aspects may be implemented in algorithms that are executed on one or more processors. In addition, the present example embodiment may employ conventional techniques for electronics environment setting, signal processing and/or data processing, and the like. The terms “mechanism,” “element,” “means,” “configuration,” and the like may be used in a broad sense and are not limited to mechanical or physical components The term may include the meaning of a series of routines of software in conjunction with a processor or the like.

The above-described example embodiments are merely examples and other example embodiments may be implemented within the scope of the following claims.

What is claimed is:

1. A method of classifying an item based on machine learning, the method comprising:
tokenizing, when pieces of information about a plurality of items are received, each of the pieces of information about the items in units of words;
creating a sub-word vector corresponding to a sub-word having a length less than a length of each of the words via machine learning;
creating a word vector corresponding to each of the words and a sentence vector corresponding to each of the pieces of information about the items based on the sub-word vectors; and
classifying the pieces of information about the plurality of items based on a similarity between the sentence vectors.

2. The method of claim 1, further comprising:
assigning a weight to the at least one word prior to performing the machine learning,
wherein the sentence vector is created according to the weight.

3. The method of claim 2, wherein the weight is changed depending on the number of attribute items included in the pieces of information about the items.

4. The method of claim 1, wherein the word vector is created on the basis of at least one of a sum or an average of the sub-word vectors.

5. The method of claim 1, further comprising:
creating a word embedding vector table having a vector corresponding to each of the words.

6. The method of claim 1, wherein the classifying of the pieces of information about the plurality of items comprises extracting the pieces of information about the plurality of items having a similarity exceeding a first threshold value.

7. The method of claim 1, further comprising:
before the tokenizing of each of the pieces of information about the items:
dividing the pieces of information about the items into one or more character strings for tagging based on at least one of a space character or a preset character included in the pieces of information about the items;
adding a tag to each of the one or more character strings for tagging via machine learning; and
determining the one or more character strings for tagging as tokens based on the tags.

8. The method of claim 7, wherein:
the tags include a start tag, a continuous tag, and an end tag, and
the determining of the one or more character strings for tagging as tokens comprises determining one token by merging a character string from a token to which the start tag is added to a token before a token to which the next start tag is added or a token to which the end tag is added.

9. An apparatus for classifying an item based on machine learning, the apparatus comprising:
a memory configured to store at least one instruction; and
a processor,
wherein the processor is configured to execute the at least one instruction to:
tokenize, when pieces of information about a plurality of items are received, each of the pieces of information about the items into units of words;
generate a sub-word vector corresponding to a sub-word having a length less than a length of each of the words via machine learning;
generate a word vector corresponding to each of the words and a sentence vector corresponding to each of the pieces of information about the items based on the sub-word vectors; and
classify the pieces of information about the plurality of items based on a similarity between the sentence vectors.

10. A computer-readable non-transitory recording medium comprising a computer program for executing a method of classifying an item based on machine learning, wherein the method for classifying an item based on machine learning comprises:
tokenizing, when pieces of information about a plurality of items are received, each of the pieces of information about the items in units of words;
creating a sub-word vector corresponding to a sub-word having a length less than a length of each of the words via machine learning;
creating a word vector corresponding to each of the words and a sentence vector corresponding to each of the pieces of information about the items based on the sub-word vectors; and
classifying the pieces of information about the plurality of items based on a similarity between the sentence vectors.
